(19) United States
(12) Patent Application Publication
(10) Pub. No.: US 2011/0303672 A1
(43) Pub. Date: Dec. 15, 2011

(54) FLAP SCORE VENTING OF CAN END

(76) Inventors: Brian Fields, Lemont, IL (US); Brendan Keane, Deerfield, IL (US)

(21) Appl. No.: 12/796,972

(22) Filed: Jun. 9, 2010

(51) Int. Cl. B65D 17/34; B26D 3/08; B65B 43/38

(52) U.S. Cl. 220/269; 53/492; 83/879

(57) ABSTRACT

A vent score lacks features to arrest score propagation. Rather encourages fast score propagation upon initial rupture. Venting is achieved through a flap configuration formed by the vent score.

### BACKGROUND OF INVENTION

This invention relates to containers, and particularly to venting pressurized containers for beverages, food, and like products.

Internal pressure in food and beverage cans may subject the scores on the ends of these cans to high forces upon tab actuation and the subsequent formation of cracks in the scores. In some circumstances, high internal pressures can cause sudden, unsafe score rupture or panel failure (for example, missiling) upon opening. Typically, can makers include a venting feature in pressurized cans to safely release internal pressure and minimize the possibility of unsafe score rupture.

To achieve venting in conventional pressurized beverage cans, can makers employ a score structure that opens in two stages. First, initial actuation of the tab ruptures a vent portion, which is a portion of the main score immediately in front of the rivet. The vent portion is separated from the main part of the score by a check slot, which has a score residual (that is, the metal at the bottom of the score) that is thicker than that of the vent portion of the score. The check slot inhibits propagation of the score rupture from the vent portion to the main portion of the score while the internal pressure vents through the crack in the vent portion. Second, the user continues to actuate the tab to rupture the check slot and propagate the score rupture around the pour opening.

Food products, especially in low internal pressure or negative pressure applications, are often packaged in cans having full aperture ends, in which a score defines a large, removable center panel. A tab is affixed to the center panel such that upon actuation of the tab, the tab nose ruptures the score. After initial actuation of the tab, a user pulls the tab upward and rearward to rupture the score about the removable center panel.

Some prior art full aperture can ends, such as disclosed U.S. Pat. No. 5,232,114 (Zysset), have a venting feature. The Zysset patent discloses a “moustache” vent score that is formed in the center panel behind a rivet for relieving internal pressure or vacuum and to promote flexibility to ease upward movement of the tab when it is lifted. Typical moustache vent scores have a central inner portion and a pair of outer portions that extend outwardly from the inner portion.

To inhibit sudden score propagation, moustache scores in food cans often are formed with increasing residual thickness. That is, the score residual of the inner portion is relatively thinner than the score residual of the outer portion that ruptures after the inner portion. Upon initial score rupture of the inner portion near the rivet, the increasing score residual thickness encountered as the score propagates resists rapid opening.

U.S. patent application Ser. No. 11/533,114 (Heinicke) is directed to venting cans having internal pressure of 25 psi or above, as sometimes found in packaging for nuts and other food items, tennis balls, and the like. The inventors of the present invention have found, however, that the venting structures disclosed in the patent application Ser. No. 11/533,114 are not suitable for cans having higher internal pressures, such as 70 psi and above, and therefore are not suitable for commercial use in pressurized cans such as for carbonated soft drinks, beer, and the like.

Conventional thinking for venting easy opening can ends has been to control, especially by temporarily inhibiting or slowing, score rupture propagation by features that mechanically arrest the score rupture, such as a check slot in beverage ends, increasing score residual in food can ends, and the break line scores in the application Ser. No. 11/533,114.

### SUMMARY

The present invention represents a new approach to venting pressure inside of a can. Rather than structurally or mechanically arresting score propagation, the present invention enables the can internal pressure to quickly rupture the vent score. Because the vent score is configured to create a flap upon rupture, the can internal pressure acts against the flap to quickly create a vent opening. The inventors have found that the flap creates an opening sufficiently large to vent can internal pressure of 70 psi or greater on an industry standard vent test. Moreover, the vent structure and methods may be useful for venting pressures lower than 70 psi in some applications.

Accordingly, a can assembly having a vent test rating of at least 70 psi includes a can body and an easy open can end that is attached to the can body by a seam. The can end includes a center panel, a main score formed in the center panel, a tab coupled to the center panel by a rivet, and a non-arresting vent score formed in the center panel (i) a central portion located rearward of a rivet centerline; (ii) a pair of lateral portions that extend transversely outwardly from the central portion; and (iii) a pair of side portions that extend rearward from ends of the lateral portions opposite the central portion. In this way, the vent score forms a flap that has a hinge formed between the rear ends of the score side portions. The vent score is configured to rupture in a non-arrested motion upon initial actuation of the tab such that the flap moves approximately about the hinge to vent the internal pressure. Preferably, the moveable panel is a removable panel on a full aperture end.

Preferably, the vent score has a substantially uniform score residual. Alternatively, the vent score residual at the central portion is at least as thick as, or thicker than, the average vent score in the lateral portions. The lateral portions of the main score extend forwardly relative to the central portion and extend to or forward of the rivet centerline.

According to another aspect of the invention, an unseamed, easy open beverage can end includes a peripheral curl capable of seaming together with a can body flange, a wall extending inwardly and downwardly from the peripheral curl, a center panel, a main score formed in the center panel that defines a movable panel, a tab coupled to the center panel by a rivet, and a non-arresting vent score formed in the center panel. The vent score includes (i) a central portion located rearward of a rivet centerline; (ii) a pair of lateral portions that extend transversely outwardly from the central portion; and (iii) a pair of side portions that extend rearward from ends of the lateral portions opposite the central portion. The vent score is capable of forming a flap having a hinge formed between rear ends of the score side portions.

Preferably, the vent score has a substantially uniform score residual. Alternatively, the vent score residual at the central portion is at least as thick as, or thicker than, the average vent score in the lateral portions. The lateral portions extend forwardly relative to the central portion, and preferably extend to or forward of the rivet centerline.

According to another aspect of the present invention, a punch tool for forming a vent score on a can end includes a base surface and a vent score punch surface extending from the base surface. The punch surface includes (i) a curved central portion located rearward of a center point that corresponds to a rivet centerline location; (ii) a pair of lateral portions that extend transversely outwardly from the central portion and (iii) a pair of side portions that extend rearward from ends of the lateral portions opposite the central portion. The vent score is capable of forming a flap with a hinge located between rear ends of the score side portions. Preferably, the punch surface extends from the base surface by an approximately uniform dimension throughout the central portion, lateral portions, and at least most of the side portions.

According to another aspect of the present invention, a method of venting a can having internal positive pressure of greater than 30 psi comprises the steps of: providing a can having an internal pressure rating of greater than 30 psi and then initiating rupture of the flap score to enable can internal pressure to propagate rupture of the flap score and to displace the flap, thereby enabling venting and promoting a large venting area. The can has an end having a tab, a main score that defines a pour opening, and a vent score that defines a flap.

The initiating step includes the flap score pivoting upwardly about a hinge. The initiating step is commenced by deflection of a rivet upon actuation of the score. The displacement of the flap and propagation of the flap score occurs without arresting.

### BRIEF DESCRIPTION OF FIGURES

FIG. 1 is a perspective view of a beverage can illustrating an embodiment of the full aperture end of the present invention, in which the tab is in an early stage of its actuation;

FIG. 2 is a top view of the can of FIG. 1, with the tab shown as transparent to illustrate the vent score;

FIG. 3 is a top view of the can of FIG. 1, with the tab removed for clarity;

FIG. 4 is a cross sectional view of the end showing its peripheral curl in its configuration before seaming on to a can body, but showing an open flap in dashed lines for reference;

FIG. 5 is an enlarged view of a portion of FIG. 2;

FIG. 6 is an enlarged cross sectional view of a portion of the can of FIG. 1;

FIG. 7 a perspective view of the rear of the can showing the vent score ruptured and flap slightly displaced to form a vent opening;

FIG. 8 is a perspective view of the beverage can of FIG. 1 showing the fully open position;

FIG. 9 is a top view of a punch for forming the vent score shown in FIG. 2; and

FIG. 10 is an enlarged view of a portion of the punch of FIG. 9.

### DETAILED DESCRIPTION OF INVENTION

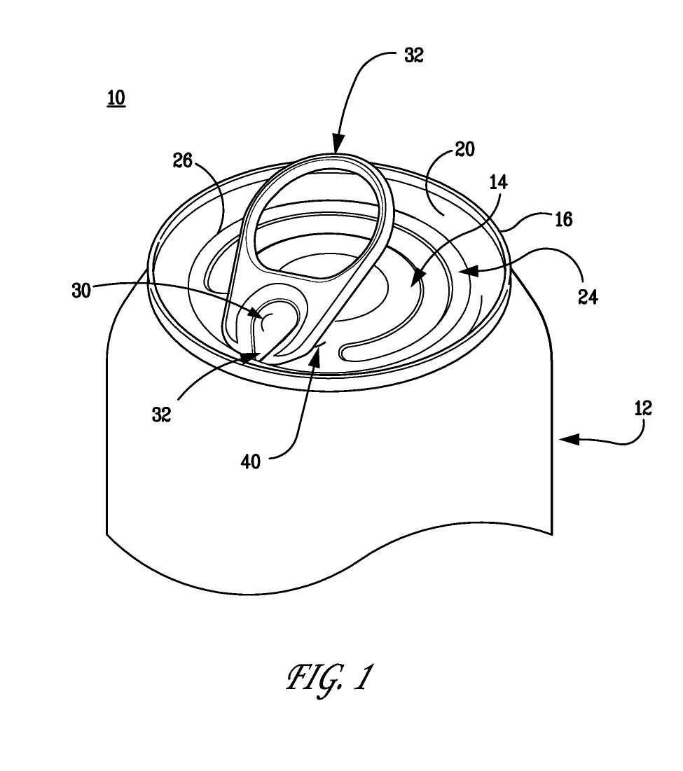

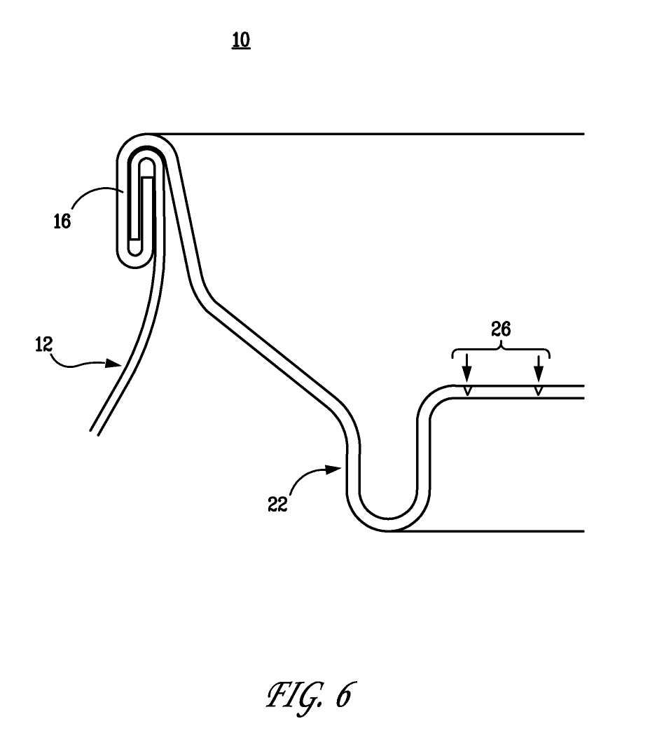

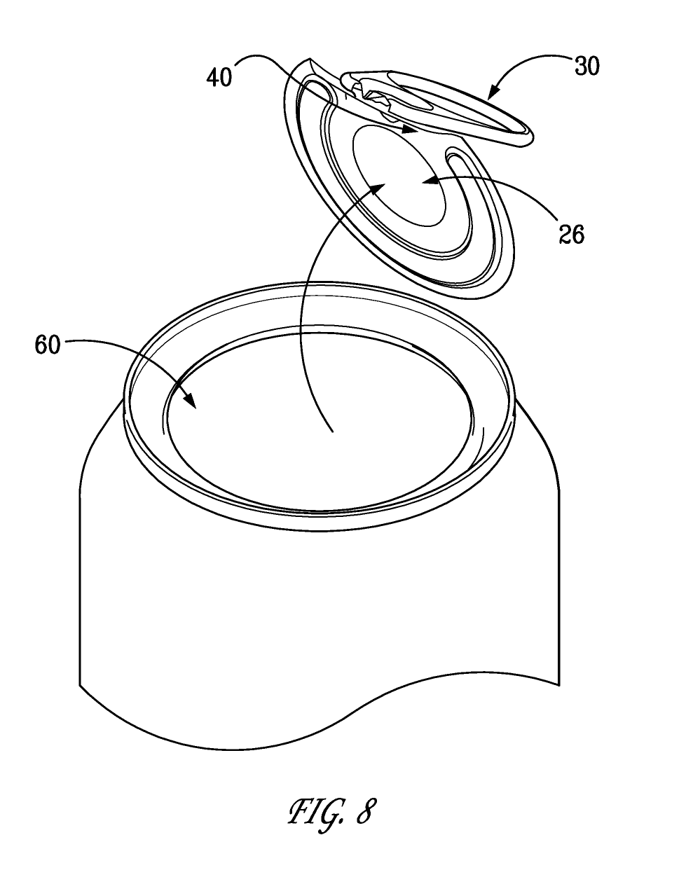

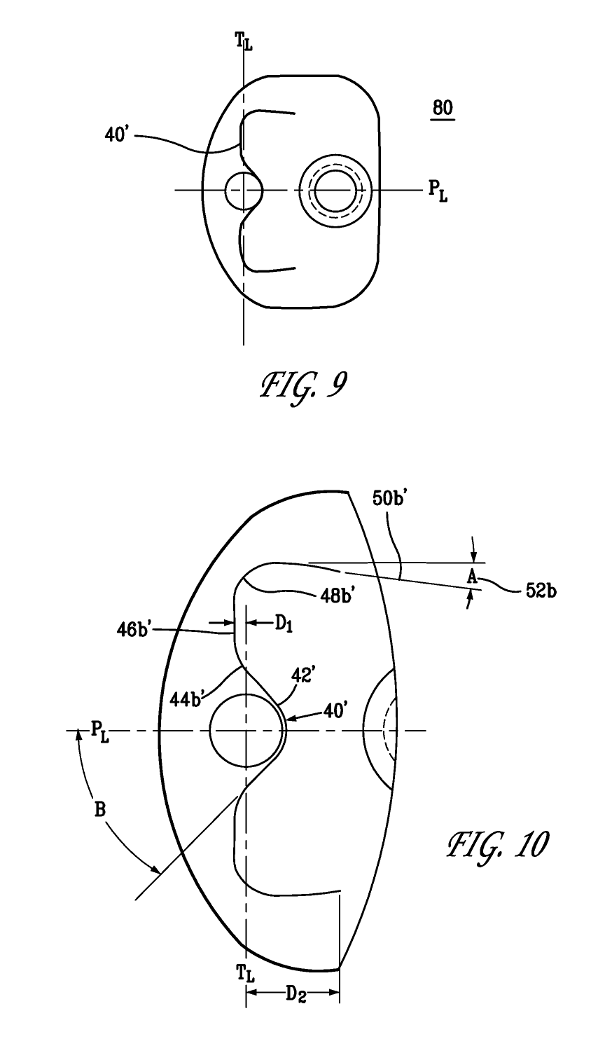

As illustrated in FIGS. 1 through 8, a can assembly 10 includes a can body 12 and an end 14. Body 12 and end 14 are joined together by a seam, preferably double seam 16. Preferably, body 12 is a conventional drawn and ironed 12 ounce or 330 ml beverage can body that is formed from a single piece of aluminum. Alternative embodiments may have bodies of different sizes, for example, 16 ounce, 20 ounce, and 32 ounce sizes and the metric volume equivalents.

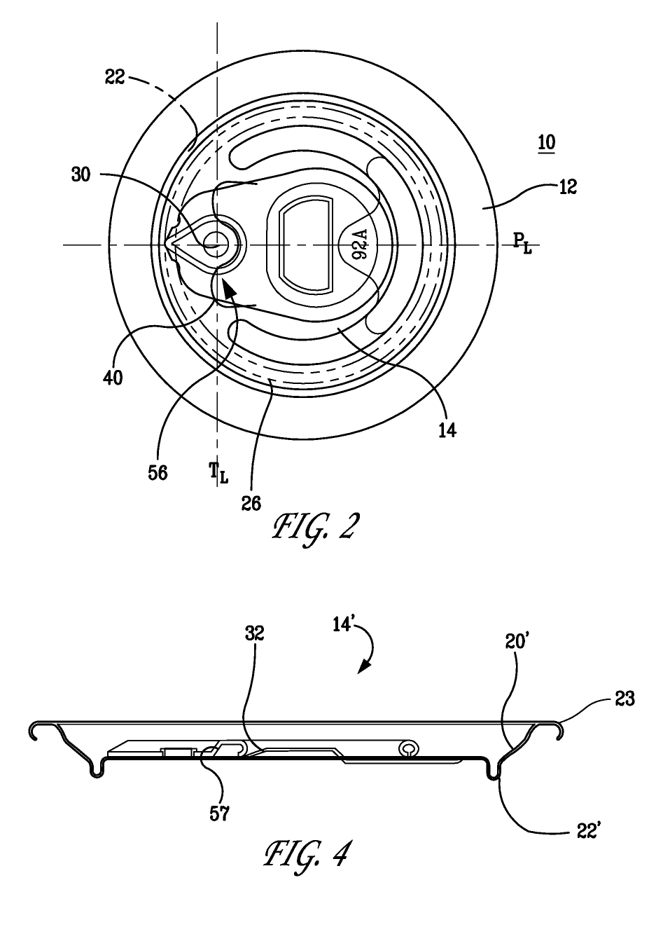

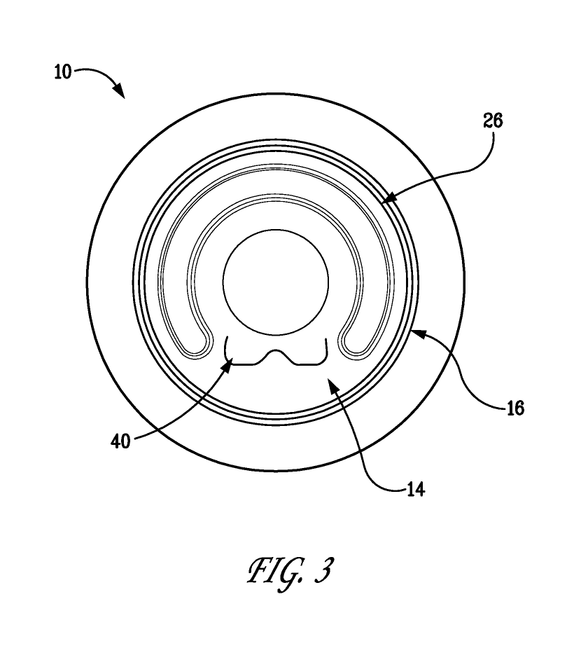

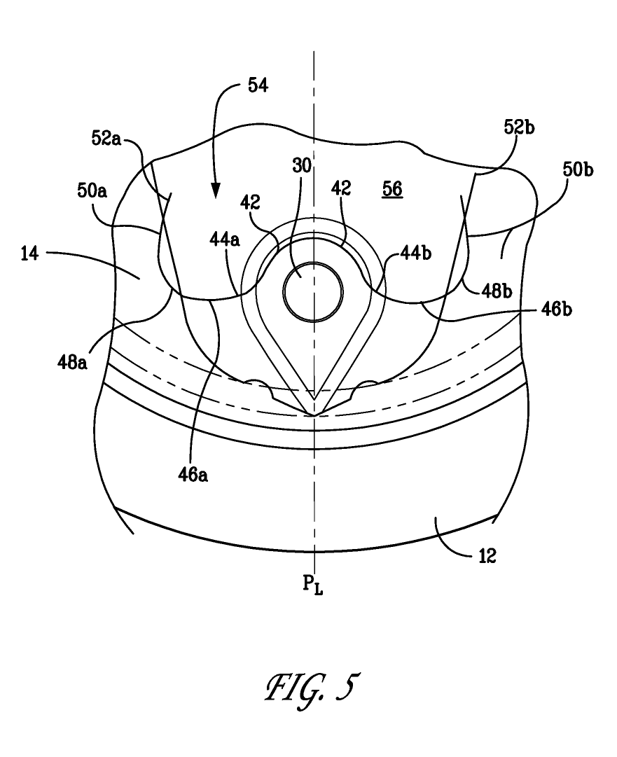

In its unseamed state shown in FIG. 4, end 14 includes a peripheral curl 23, a wall 20, a countersink 22, and a center panel 24. As best shown in FIGS. 1, 2, and 3, in its seamed state, peripheral curl has been manipulated to form a part of seam 16. The end preferably is a 202, 204, or 206 size, although the present invention encompasses any size of end. The present invention also encompasses any configuration of wall 20 and countersink 22. Wall configurations may include straight (B64) walls, inclined chuck walls, curved chuck walls, multipart chuck walls, chuck walls with features such as shelves, kicks, etc., and the like. Countersink configurations may include countersinks with straight sidewalls, curved sidewalls, narrow beads, broad beads, folded or pinched beads, and the like. The configurations of the ends, walls, and countersinks contemplated by the present invention include those marketed or sold by Crown Cork & Seal Co., Ball Corp., Metal Container Corp. Container Development Ltd., and Rexam Ltd.

Further, the present invention is illustrated on a beverage can end that is preferably formed from a 5000 series aluminum alloy. The present invention is especially suited to this conventional aluminum alloy because of its tendency to tear at the end of the scores. The present invention is not limited to this particular alloy but rather encompasses steel, such as tin plate, other grades of aluminum, and the like.

Center panel 24 is circular and includes a main score 26, a rivet 30, and a vent score 40. A tab 32 is affixed to center panel 24 by rivet 30. Main score 26 is continuous to form a removable panel 34. Rivet 30 is formed on removable panel 34. Tab 32 is affixed to removable panel 34 by rivet 30.

To aid in the description of center panel 24, primary or center reference line P_{L} is defined as extending through the center of rivet 30 and through the longitudinal centerline of tab 32. For the vast majority of commercial tabs, primary reference line P_{L} will extend through the point of initial contact between the nose of tab 32 and its point of initial contact on the center panel. Transverse reference line T_{L} is defined as extending through the center of rivet 30 and perpendicular to the primary reference line P_{L}. The plane defined by lines P_{L} and T_{L} is parallel to the plane defined by the top of the seam and parallel to center panel 24, to the extent that center panel 24 defines a plane in its seamed or unseamed state. Primary reference line P_{L} divides can end 14 into a front portion on the side of the tab nose and a rear portion on the side of the tab heel.

Vent score 40 includes a central portion 42, a pair or lateral portions 46a and 46b, and a pair of side portions 50a and 50b. As best shown in FIG. 5, central portion 42 of vent score 40 is rounded as it extends around the rear center portion of rivet 30. Opposing ends of central portion 42 extend forward about the rivet toward transverse reference line T_{L}. Ends of central portion 42 yield to corresponding inner ends of lateral portions 46a and 46b through transitions 44a and 44b, which preferably are approximately straight and angled from primary reference line P_{L} by an angle B that is approximately 45 degrees. Lateral portions 46a and 46b extend generally laterally (that is, generally parallel to transverse reference line T_{L}) and outwardly relative to rivet 30. Side portions 50a and 50b extend generally rearward from outer ends of lateral portions 46a and 46b through transitions 48a and 48b. Side portions 50a and 50b end at terminations 52a and 52b. The vent score terminations may be curved, curled, or angled relative to the side portions of the vent score, or they may simply be the ends of straight side walls, as shown in the figures.

A hinge 54 is formed on the removable panel 34 between terminations 52a and 52b of side portions 50a and 50b. A flap 56 is defined by vent score 40 and hinge 54. A front portion of flap 56 is defined by central portion 42 and lateral portions 46a and 46b. Sides of flap 56 are defined by side portions 50a and 50b. The rear of flap 56 is formed (with less specificity in its location) by hinge 54. After rupture of vent score 40 (that is, when the flap is in its up or open position), the flap is referred to by reference numeral 57, which is schematically shown in FIG. 4.

Dimensional information of vent score 40 is provided with reference to the enlarged view of the tool 80 for forming the vent score in FIG. 10. Preferably, a portion of vent score 40 extends to (or approximately to) or forward of the transverse reference line T_{L} to promote movement or hinging of the tab and rivet. For example, lateral portions 46a and 46b preferably extend forward of transverse line T_{L} by a dimension D₁. Preferably, D₁ is positive and between 0 and 0.050 inches, and more preferably between 0.010 inches and 0.032 inches. In the embodiment shown in the figures, D₁ is approximately 0.021 inches.

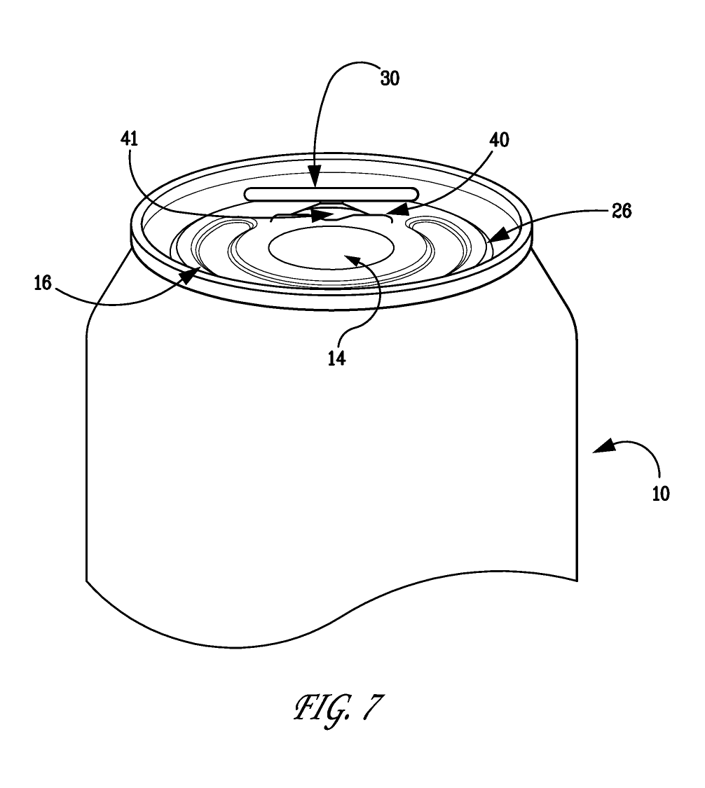

Side portions 50a and 50b are mutually spaced apart and extend rearwardly such that flap 56/57 creates sufficient area for venting. The vent opening is shown in FIG. 7 as reference numeral 41. In this regard, side portions 50a and 50b preferably extend rearwardly from transverse reference line T_{L} by a distance D₂ that preferably is between 0.15 and 0.4 inches, and more preferably is between 0.2 and 0.3 inches. In the embodiment shown in the figures, D₂ is 0.238 inches. The ends of side portion terminations 52a and 52b are spaced apart by a distance of between 0.5 inches and 1.0 inches and preferably between 0.6 and 0.8 inches. In the embodiment shown, the distance between 52a and 52b is 0.742 inches.

Vent score sides may be curved or straight, and oriented at any angle A, measured relative to primary reference line P_{L}. For example, A may be approximately zero (that is, the vent score sides may be approximately parallel to primary reference line P-L), between +/−10 degrees, between +/−20 degrees, or between +/−30 degrees. In the embodiment shown in the figures, angle A is 5 degrees. Central portion 42 and lateral portions 46a and 46b may be shapes other than as shown in the figures.

Preferably, vent score 40 has an approximately uniform score residual dimension at least through score central portion 42, lateral portions 46a and 46b, and the front portion of score side portions 50a and 50b. Preferably, the score residual dimension is between 0.0020 and 0.0045 inches. The anvil against which tool 80 acts optionally has a step to control the residual dimension. Regarding the residual thickness, vent score 40 does not have a check slot (that is, a portion of the score having a thickened score residual intended to arrest score propagation), and does not have a gradually increasing score residual in the direction of propagation, or other features that would tend to arrest score propagation. The present invention is not limited solely to score configurations having perfectly uniform score residuals, but rather encompasses variations of the score residual so long as either score propagation is not arrested or the flap function is not prevented. Further, score arresting features have been used in prior art ends to pause or resist score propagation in an effort to structurally prevent missiling or similar types of failures.

The present invention encompasses, however, a thickened score residual at the point of initial rupture of the vent score. For example, the score residual thickness in the center of central portion 42 may be thicker than in the score residual in the lateral portions 46a and 46b and side portions 50a and 50b. The thickened central portion score residual may enable energy to build up in the panel during tab actuation to aid in score propagation upon initial rupture. For example, for the vent score residual dimensions may be approximately between 0.0020 and 0.0045 inches and the thickened central portion may be greater approximately by 0.001 or 0.002 inches, preferably approximately between 0.0030 and 0.0045 inches.

The beverage can industry uses an industry standard “vent test”, also known as an “anti-missiling test”, to assess the ability of an end to safely and effectively function under pressurization. The inventors have demonstrated that can assembly 10 and end 14 described above achieved 85 psi rating on the industry standard vent test, which enables can assembly 10 to be commercially sold for beer. Achieving vent test ratings of over 70 psi is significant for full aperture can 10. Further, the vest test performance enables can 10 suitable for withstanding the internal pressures created during can pasteurization.

The present invention encompasses any shape of the vent score and any shape of the flap as broadly stated in the claims. The shape and dimensions provided above for vent score 40 and flap 56 are for illustration only and are not intended to be limiting. Each dimension provided above is approximate. As will be understood by persons familiar with can end engineering, the dimensions provided in this specification may be determined by various parameters for the particular application, including end material and thickness, internal pressure specifications, flap dimensions and area, and the like.

Referring especially to FIGS. 1, 2, 7, and 8 to describe the operation of can assembly 10 and to illustrate the corresponding inventive method, can assembly 10 has internal pressure, such as when filled with a carbonated soft drink, beer, or the like. Scores 26 and 40 are intact and tab 32 is in its conventional rest portion of approximately flat against center panel 24 or approximately horizontal.

A user lifts the heel end of tab 32, which moves the tab nose toward center panel 24 while deflecting the metal around the rivet until score central portion 42 ruptures, as shown in FIG. 7. Preferably, a portion of vent score 40 ruptures before any portion of main score 26 ruptures to achieve venting. The rupture of vent score 40 propagates quickly through lateral portions 46a and 46b and rearward through score side portions 50a and 50b as flap 56 moves upwardly about hinge 54. In this regard, the can internal pressure actuates flap 56 to quickly produce a relatively large open area for can venting. The open position of flap 56 is illustrated schematically by dashed lines and reference numeral 57 in FIG. 4. Then, similar to the opening of conventional can ends, the user continues to actuate tab 32 until the main score 24 ruptures and removable panel 26 is detached.

The embodiments shown in the figures and described above illustrate aspects of the present invention. The present invention is not limited to the particular embodiments shown in the figures, but encompasses structures and methods broader than the disclosure and limited only by the claims. For example, the present invention encompasses materials, chuck wall configuration, seam structure and processes, removable or hinged tear panel configuration, that are not shown in the figures unless limited in the claims.

1. A can assembly having a vent test rating of at least 70 psi, the can assembly comprising:
a can body;
an easy open can end that is attached to the can body by a seam; the can end including:
a center panel;
a main score formed in the center panel;
a tab coupled to the center panel by a rivet; and
a non-arresting vent score formed in the center panel including (i) a central portion located rearward of a rivet centerline; (ii) a pair of lateral portions that extend transversely outwardly from the central portion and (iii) a pair of side portions that extend rearward from ends of the lateral portions opposite the central portion, the vent score forming a flap having a hinge formed between rear ends of the score side portions;
whereby, the vent score is configured to rupture in a non-arrested motion upon initial actuation of the tab such that the flap moves approximately about the hinge to vent the internal pressure.

2. The can assembly of claim 1 wherein the vent score has a substantially uniform score residual.

3. The can assembly of claim 1 wherein the lateral portions extend forwardly relative to the central portion.

4. The can assembly of claim 1 wherein the lateral portions extend to or forward of the rivet centerline.

5. The can assembly of claim 1 wherein the average vent score residual at the central portion is at least as thick as the average vent score in the lateral portions.

6. The can assembly of claim 1 wherein the moveable panel is a removable panel on a full aperture end.

7. An unseamed, easy open beverage can end comprising
a peripheral curl capable of seaming together with a can body flange;
a wall extending inwardly and downwardly from the peripheral curl;
a center panel;
a main score formed in the center panel, the score defining a movable panel;
a tab coupled to the center panel by a rivet; and
a non-arresting vent score formed in the center panel including (i) a central portion located rearward of a rivet centerline; (ii) a pair of lateral portions that extend transversely outwardly from the central portion and (iii) a pair of side portions that extend rearward from ends of the lateral portions opposite the central portion, the vent score is capable of rupture for forming a flap having a hinge formed between rear ends of the score side portions.

8. The can assembly of claim 7 wherein the vent score has a substantially uniform score residual.

9. The can assembly of claim 7 wherein the lateral portions extend forwardly relative to the central portion.

10. The can assembly of claim 7 wherein the lateral portions extend to or forward of the rivet centerline.

11. The can assembly of claim 7 wherein the average vent score residual at the central portion is at least as thick as the average vent score in the lateral portions.

12. A punch tool for forming a vent score on a can end, the tool comprising:
a base surface;
a vent score punch surface extending from the base surface, the punch surface including (i) a curved central portion located rearward of a center point that corresponds to a rivet centerline location; (ii) a pair of lateral portions that extend transversely outwardly from the central portion and (iii) a pair of side portions that extend rearward from ends of the lateral portions opposite the central portion, the vent score capable of forming a flap having a hinge formed between rear ends of the score side portions.

13. The punch tool of claim 12 wherein the punch surface extends from the base surface by an approximately uniform dimension throughout the central portion, lateral portions, and at least most of the side portions.

14. A method of venting a can having internal positive pressure of greater than 30 psi comprising the steps of:
providing a can having an internal pressure rating of greater than 30 psi and including an end having a tab, a main score that defines a pour opening, and a flap score that defines a flap;
initiating rupture of the flap score to enable can internal pressure to propagate rupture of the flap score and to displace the flap, thereby enabling venting of the internal pressure.

15. The method of claim 14 wherein the initiating step includes the flap score pivoting upwardly about a hinge.

16. The method of claim 14 wherein initiating step is commenced by deflection of a rivet upon actuation of the score.

17. The method of claim 14 wherein the displacement of the flap and propagation of the flap score occurs without arresting.
